(19) United States
(12) Patent Application Publication
(10) Pub. No.: US 2009/0162806 A1
(43) Pub. Date: Jun. 25, 2009

(54) REPLACEMENT TOOTH

(76) Inventor: Keith Wickizer, Mt. Pleasant, SC (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 12/333,510

(22) Filed: Dec. 12, 2008

Related U.S. Application Data
(60) Provisional application No. 61/013,176, filed on Dec. 12, 2007.

(51) Int. Cl. A61C 7/14

(52) U.S. Cl. 433/8

(57) ABSTRACT

The present invention relates to a replacement tooth that includes a tooth body and a bracket. The bracket is coupled to the tooth body and includes at least one prong for communicating with an orthodontic apparatus. The bracket also includes a retaining plate that is embedded within the tooth for anchoring the bracket to the tooth body.

### CROSS REFERENCE TO RELATED APPLICATION

This application claims priority to U.S. provisional patent application Ser. No. 61,013,176 filed Dec. 12, 2007,entitled “REPLACEMENT TOOTH”, which is incorporated herein by reference in its entirety.

### BACKGROUND OF THE INVENTION

Often, when a dentist or orthodontist installs braces or other orthodontic tools into a user's mouth, the doctor must remove one or more teeth. By removing one or more teeth, the doctor opens up additional space in a user's mouth in which to straighten or align the user's remaining teeth. However, by removing one or more teeth from the user's mouth, the user is typically temporarily left with a significant gap between the user's remaining teeth. Additionally, patients visit dentists and/or orthodontists who already have missing teeth and/or gaps between adjacent teeth. These types of gaps are often unsightly.

Generally, there are a couple of known methods that dentists/orthodontists use to hide the gaps temporarily created by the removal of one or more teeth from the user's mouth. Typically, the doctor inserts a replacement tooth into the area where the tooth/teeth were pulled—either by connecting the replacement to the braces or by using a denture-like system. A replacement tooth can be acquired by making a mold of the tooth/teeth that were pulled or by simply purchasing denture teeth for all those pulled. However, it has been found that it is difficult to reliably secure the replacement tooth to the braces. Typically, a metal bracket is attached to the tooth for connecting the tooth to the braces by gluing a metal bracket to the outside face of the same. Even when the tooth is successfully connected to the braces, it has been found that the tooth cannot be secured sufficiently because the glue-bond between the metal bracket and tooth often is compromised.

Additionally, students learning about orthodontics often work with dentures/replacement teeth that incorporate glue-bonded brackets. In fact, it has been found that student handling of such teeth often results in the bracket breaking off—due to forces applied to the bracket or simply because the glue-bond has weakened. Training models used in the teaching of orthodontics also incorporate such teeth, which tend to have similar problems as described above. For example, this weak glue-bond interface is often noticed when students are training in orthodontic schools and offices where the adjustment of braces (or other orthodontic apparatuses), removing ligatures, changing arch wires, etc. exerts debonding forces on the teeth/bracket combination.

Therefore, it can be seen that needs exist for replacement teeth for use with braces, orthodontic apparatuses, dental models, etc. that are easy to attach and can be secured in place. It is to the provision of these needs and others that the present invention is primarily directed.

### SUMMARY OF THE INVENTION

The present invention thus relates to a replacement tooth that includes a permanently attached bracket for engaging an orthodontic apparatus. As such, it is very difficult for the bracket to break free from the tooth and minimizes the replacement time and costs that can be associated therewith. More specifically, in one aspect, the present invention relates to a replacement tooth that includes a tooth body and a bracket. The bracket is coupled to the tooth body and includes at least one prong for communicating with an orthodontic apparatus. The bracket also includes a retaining plate that is embedded within the tooth for anchoring the bracket to the tooth body.

In another aspect, the present invention relates to a replacement tooth that includes a tooth body and a bracket extending therefrom. The bracket includes at least one prong for receiving a corresponding component from an orthodontic apparatus. The bracket and the tooth body are formed together, such that the bracket and tooth body are a unitary object.

In still another aspect, the present invention relates to an orthodontic kit. The kit includes at least one orthodontic apparatus having a wire for communicating with a replacement tooth. Additionally, the kit includes a replacement tooth that has a tooth body and a bracket permanently coupled to the tooth body. The bracket includes at least one prong for communicating with the wire and a retaining instrument that is embedded within the tooth body.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWING FIGURES

FIG. 1 is a front view of a replacement tooth according to an example embodiment of the present invention.

FIG. 2 is a side view of the replacement tooth of FIG. 1.

FIG. 3 is a front view of the replacement tooth of FIG. 1, shown being inserted into a user's mouth.

FIG. 4 is a side view of a replacement tooth according to another example embodiment of the present invention.

FIG. 5 is a front view of the replacement tooth of FIG. 4.

### DETAILED DESCRIPTION OF THE EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

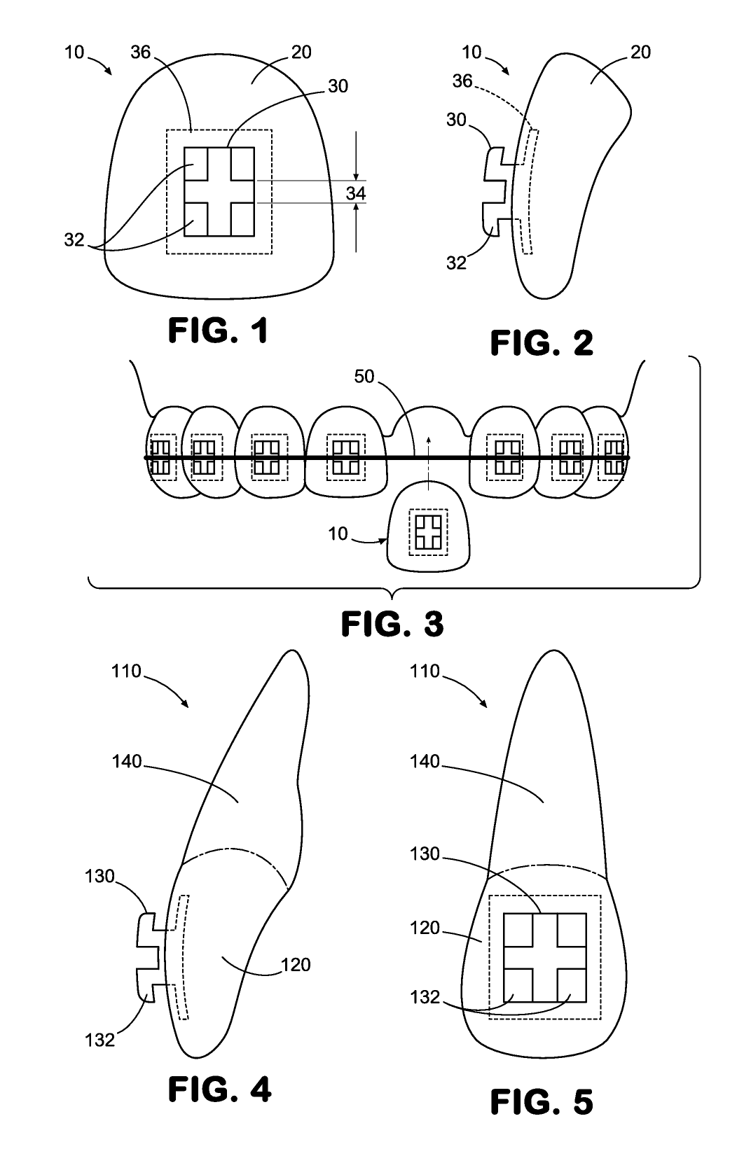

With reference now to the drawing figures, FIGS. 1-3 show a replacement tooth 10 according to an example embodiment of the present invention. The replacement tooth 10 of the present invention generally includes a tooth body 20 and a bracket 30. In preferred embodiments of the present invention, the bracket 30 of the tooth 10 is partially molded within the tooth body 20 as better seen in FIG. 2, such that the bracket is mechanically retained within the tooth body. Mechanical retention of the bracket 30 within the tooth body 20 can be accomplished with conventional fasteners such as glue, epoxy, clips, hooks, etc. or the bracket can be molded within the tooth body—such that the bracket forms a unitary structure with the tooth body. In preferred example embodiments, the bracket 30 is partially molded within the tooth body 20. The tooth body 20 can be constructed from any number of known materials used in replacement tooth construction (e.g. acrylic, porcelain, rubber and/or plastic). Alternatively, the tooth body 20 can be constructed from metal. Additionally, the tooth body 20 can be colored in various shades to match the color of the user's teeth.

The replacement tooth 10 of the present invention can be used to fill in gaps or holes between adjacent teeth within a user's mouth. It has been found that the invention is particularly suited for filling in holes or gaps in a user's teeth after one or more teeth have been removed for braces or other orthodontic apparatuses. In example embodiments, the bracket 30 includes at least one prong 32 that extends from the body 20 of the tooth 10 to engage an orthodontic apparatus or accessory. Alternatively, the bracket 30 can include hooks and/or clips instead of the at least one prong 32. In preferred example embodiments, the bracket 30 includes four prongs 32 as depicted in the drawing figures. Alternatively, the bracket 30 can include two, three, five, or six prongs 32. In still other embodiments, the bracket 30 can be multiple shapes and/or configurations as desired. The bracket 30 of the replacement tooth 10 can be coupled to the wires of the braces/orthodontic apparatus and reliably secured thereto. In this regard, the bracket 30 includes at least one slot 34 for receiving orthodontic wire 50 (see FIG. 3) therein. The bracket 30 can be attached to the wires by normal orthodontic methods (i.e., elastic ties, steel ligatures, or self-ligating clips, etc) and the slot 34 width can vary to fit around corresponding wire sizes. In preferred example embodiments, the slot 34 is either an 18 or 22 slot (0.018 inches and 0.022 inches, respectfully); however, alternative embodiments can employ variable slot sizes as desired. For example, the slot 34 can be between about 0.014 inches and about 0.026 inches in width. Alternatively, the slot can be between about 0.010 inches and about 0.030 inches in width.

In example embodiments, the bracket 30 also incorporates a retaining plate 36 that is preferably molded within the tooth body 20. The retaining plate 36 serves to permanently anchor the bracket 30 to the tooth body 20. In commercial embodiments, the retaining plate 36 is a substantially flat insert that is substantially surrounded by the tooth body 20. In other embodiments, screws, hooks, or other conventional fasteners can replace the retaining plate 36 as anchors for the bracket 30. In example embodiments, the retaining plate 36 is coated in an opaquing agent so that the plate is not visible through the tooth body 20. In alternative embodiments, the replacement tooth 10 does not utilize a retaining plate 36, and instead is formed from a unitary mold that incorporates a bracket 30 therein.

The bracket 30 can be constructed of various materials, but in example embodiments, the bracket is formed from metal. In other example embodiments, the bracket 30 is formed from acrylic, porcelain, rubber and/or plastic. In still other embodiments, the present invention includes a molded tooth that incorporates one or more prongs 32 extending therefrom, such that there is no distinction between the tooth 10 and the prong(s) 32.

In operation, a dentist/orthodontist can use the replacement tooth 10 of the present invention to conceal a gap in a user's teeth. In example embodiments, the tooth body 20 is shaped to replicate the shape of the tooth that the replacement tooth 10 is replacing, or at least temporarily replacing (or appropriately shaped to conceal a particular gap between adjacent teeth). Alternatively, the tooth of the present invention can be manufactured in variable sizes to fit a wide variety of users' mouths. Regardless of the particular shape, the dentist/orthodontist can insert the replacement tooth 10 into the gap as desired and connect the bracket 30 to an orthodontic apparatus/accessory (e.g. braces wire). When connecting the replacement tooth to braces wire, the dentist/orthodontist can thread the wire 50 (see FIG. 3) through the slot 34 and secure the bracket 30 thereto using traditional methods. Forces applied to the tooth 10 by the user (such as exerted when masticating) are spread out throughout the tooth body 20 and thus prevents the bracket from breaking away from the tooth body. As the gaps between the user's teeth diminish over time—such as when the replacement tooth 10 of the present invention is incorporated with braces—a user can repetitively utilize smaller replacement teeth 10 to fill in the gaps/holes until a replacement tooth is no longer needed (i.e. the gap between adjacent teeth no longer necessitates concealment). Alternatively, the tooth 10 can be shaved down as needed to conceal a user's gap over time.

In other embodiments, the present invention can be utilized as a training tool for students. Because the bracket 30 and the tooth body 20 are incorporated into the same tooth mold 10, it allows significant student manipulation of the tooth 10 with little worry over breaking the bracket from the body—as is typical of glue-bonded known replacement teeth.

In another example embodiment, as seen in FIGS. 4-5, the present invention can take the form of a typodont/study model tooth 110. In example embodiments, the typodont/study model tooth 110 includes a body 120, connecting bracket 130, and gum insert 140. Similarly to the example embodiment depicted in FIGS. 4-5, the bracket 130 is partially formed within the tooth body 120, such that the bracket forms part of the replacement tooth 10. The bracket 130 preferably includes at least one prong 132 for connecting the typodont/study model tooth to braces wire or other orthodontic tools and a retaining plate 136 to anchor the bracket within the tooth body. In other example embodiments, the bracket 130 includes 4 prongs 132. Alternatively, the bracket 130 can include hooks and/or clips in place of the one or more prongs 132. The typodont/study model tooth 110 can also be used concurrently with a tooth set model (typodont) by attachment to artificial gingival (gums) by friction, screws, or other conventional fasteners. In this regard, a student/assistant can then utilize the typodont model to practice.

In still other example embodiments, the present invention comprises an orthodontic kit that includes one or more orthodontic apparatuses (braces, wires, retainer, etc.) in combination with one or more replacement teeth according to the present invention. The kit can include variable sizes of replacement teeth and/or replacement teeth that can be sized to fit a particular patient. In commercial embodiments, the kit is prepackaged with one or more replacement teeth 10 and one or more orthodontic apparatuses.

While the invention has been described with reference to preferred and example embodiments, it will be understood by those skilled in the art that a variety of modifications, additions and deletions are within the scope of the invention, as defined by the following claims.

What is claimed is:

1. A replacement tooth comprising:
a tooth body; and
a bracket coupled to the tooth body, the bracket having at least one prong for communicating with an orthodontic apparatus and a retaining plate embedded within the tooth body for anchoring the bracket to the tooth body.

2. The replacement tooth of claim 1, wherein the bracket includes four prongs.

3. The replacement tooth of claim 1, wherein the bracket includes at least two prongs and a slot is formed between the at least two prongs.

4. The replacement tooth of claim 3, wherein the slot is between about 0.014 inches and about 0.026 inches in width.

5. The replacement tooth of claim 3, wherein the slot is between about 0.010 inches and about 0.030 inches in width.

6. The replacement tooth of claim 1, wherein the retaining plate is coated with an opaquing agent.

7. The replacement tooth of claim 1, wherein the bracket is formed from at least one of acrylic, porcelain, rubber, metal and plastic.

8. The replacement tooth of claim 7, wherein the tooth body is formed from at least one of acrylic, porcelain, rubber, metal and plastic.

9. The replacement tooth of claim 1, wherein the tooth body includes a gum insert.

10. A replacement tooth comprising:
a tooth body; and
a bracket extending from the tooth body, the bracket having at least one prong for receiving a corresponding component of an orthodontic apparatus;
wherein the bracket is integrally formed in the tooth body.

11. The replacement tooth of claim 10, wherein the bracket includes at least two prongs.

12. The replacement tooth of claim 11, wherein a slot is formed between the at least two prongs and the slot width is between about 0.010 inches and about 0.030 inches.

13. The replacement tooth of claim 10, wherein the bracket includes four prongs adapted to receive arch wire.

14. The replacement tooth of claim 10, wherein the tooth body includes a gum insert.

15. A kit comprising:
at least one orthodontic apparatus having a wire for communicating with a replacement tooth; and
a replacement tooth having a tooth body and a bracket permanently coupled to the tooth body, the bracket including at least one prong for communicating with the wire and a retaining instrument that is embedded within the tooth body.
